(19) United States
(12) Patent Application Publication
(10) Pub. No.: US 2026/0219241 A1
(43) Pub. Date: Jul. 30, 2026

(54) FRACTIONATION METHOD AND FRACTIONATION APPARATUS

(71) Applicant: SHIMADZU CORPORATION, Kyoto (JP)

(72) Inventor: Kazuhiro KAWAKAMI, Kyoto (JP)

(73) Assignee: SHIMADZU CORPORATION, Kyoto (JP)

(21) Appl. No.: 19/398,632

(22) Filed: Nov. 24, 2025

(30) Foreign Application Priority Data
Jan. 24, 2025 (JP) 2025-010359

(51) Int. Cl. G01N 30/32; B01D 15/16; B01D 15/42; G01N 30/62

(52) U.S. Cl. CPC G01N 30/32; B01D 15/163; B01D 15/424; G01N 30/62; G01N 2030/324

(57) ABSTRACT

A method for fractionating a target component from a measurement sample comprises a separation step of separating the target component, a trapping step of trapping the separated target component in a trap column, an elution step of causing the target component to flow out from the trap column, and a recovery step of recovering the target component that has flowed out from the trap column, wherein, in the elution step, water and the target component discharged from the trap column are separated by adjusting an inflow rate of an elution organic solvent into the trap column.

### CROSS REFERENCE TO RELATED APPLICATIONS

This application claims priority to Japanese Patent Application No. 2025-010359 filed on January 24, 2025, the entire disclosure of which is incorporated by reference herein.

### TECHNICAL FIELD

The present invention relates to a fractionation method and a fractionation apparatus.

### BACKGROUND ART

A preparative LC apparatus has been provided that separates a measurement sample by liquid chromatography and then continuously (online) purifies and recovers each separated component (see, for example, Patent Literature 1). Specifically, in an LC unit (separation unit), a measurement sample is passed through a separation column together with a mobile phase, thereby separating a plurality of target components from the measurement sample. Subsequently, in a purification unit, each target component is temporarily trapped in a trap column, then each target component is eluted with an eluent and individually recovered. Using this preparative LC apparatus allows for the individual purification and recovery of a plurality of target components mixed in a measurement sample, enabling further detailed analysis of the target components by subjecting the target components to an analyzer such as a nuclear magnetic resonance spectrometer for each type.

### CITATION LIST

### Patent Literature

[Patent Literature 1] WO 2017/033256

### SUMMARY OF INVENTION

### Technical Problem

By the way, in preparative LC apparatuses, in the LC unit for separating a measurement sample, it is practiced to mix a water-containing mobile phase with the measurement sample and pass it through a separation column in a separation mode based on reversed-phase chromatography. In this separation mode, each target component subsequently enters a trap column together with the water-containing mobile phase in the purification unit. Therefore, when eluting the target component trapped in the trap column into an eluent and recovering it with the eluent, a problem occurs in which water is mixed into the recovered target component in addition to the eluent. Furthermore, regardless of the separation mode, the target component trapped in the trap column may be washed using a water-containing liquid (such as a diluent), and in this case as well, water enters the trap column, causing a problem where water mixes into the eluent. Since water contamination adversely affects subsequent analysis, it is necessary to perform water removal operations (e.g., drying, distillation) on the recovered target component, which takes time and effort.

The present invention can suppress water contamination in a fractionated target component.

### Solution to Problem

A fractionation method according to a first aspect of the present invention sequentially comprises a separation step of separating a target component in a sample solution by passing the sample solution through a separation column, a trapping step of

trapping the separated target component in a trap column, an elution step of eluting the target component from the trap column by causing an elution organic solvent to flow into the trap column, and a recovery step of recovering the target component eluted from the trap column, wherein, in the elution step, water and the target component discharged from the trap column are separated by controlling a flow rate of the elution organic solvent into the trap column.

A fractionation apparatus according to a first aspect of the present invention is an apparatus for implementing the fractionation method according to the first aspect, comprising a separation column for separating the target component, a trap column for trapping the separated target component, elution means for causing the elution organic solvent to flow into the trap column, recovery means for recovering the target component that has flowed out from the trap column, and control means for adjusting the inflow rate of the elution organic solvent into the trap column.

### Advantageous Effects of Invention

According to the first aspect of the present invention, a target component can be fractionated while suppressing water contamination.

### BRIEF DESCRIPTION OF DRAWINGS

FIG. 1 shows an image diagram of a fractionation apparatus during separation and trapping of a target component in a first embodiment.

FIG. 2 shows an image diagram of the fractionation apparatus during elution and recovery of the target component in the first embodiment.

FIG. 3 shows a chromatogram output by a second detector in Example 1. The horizontal axis indicates elution time, and the vertical axis indicates signal intensity.

FIG. 4 shows a chromatogram output by the second detector in Example 2.

FIG. 5 shows a chromatogram output by the second detector in Example 3.

FIG. 6 shows a chromatogram output by the second detector in Example 4.

FIG. 7 shows a chromatogram output by the second detector in Comparative Example 1.

FIG. 8 shows a chromatogram output by the second detector in Comparative Example 2.

FIG. 9 shows a chromatogram output by the second detector in Comparative Example 3.

### DESCRIPTION OF EMBODIMENTS

### First Embodiment

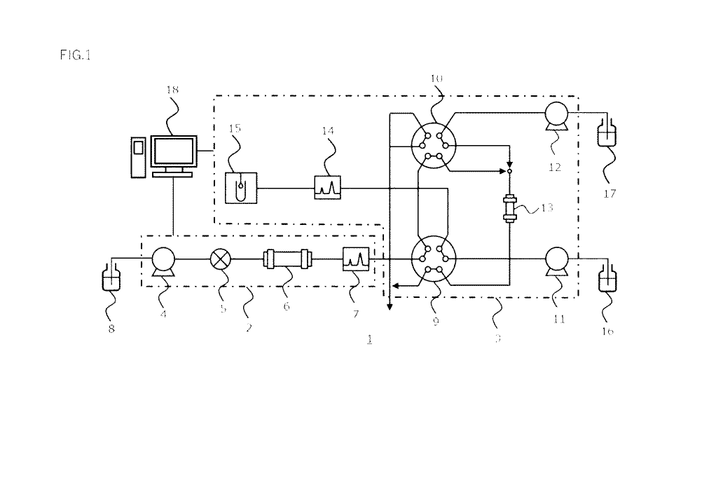

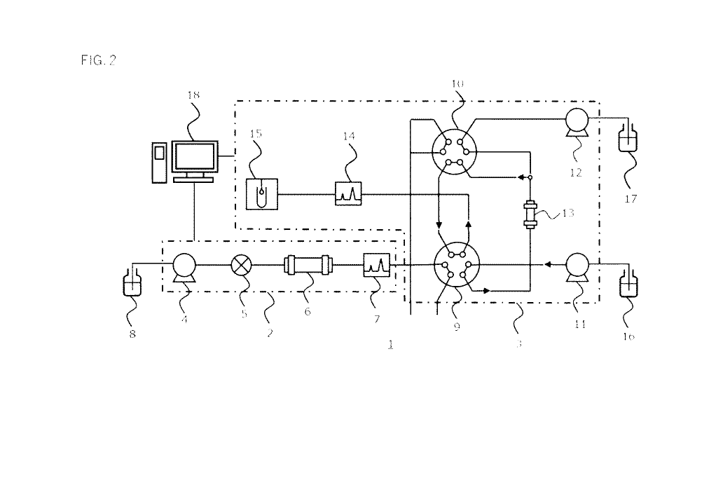

1-1. Fractionation Apparatus An example of a fractionation apparatus of a first embodiment used in the first aspect of the present invention will be described with reference to FIGS. 1 and 2. This fractionation apparatus 1 is a chromatographic preparative purification apparatus and continuously includes a separation unit 2 and a purification unit 3, as shown in FIGS. 1 and 2.

The separation unit 2 is means for performing separation by liquid chromatography, and includes a separation pump 4, a sample injection unit 5, a separation column 6, and a first detector 7. The separation pump 4 sends a mobile phase stored in a mobile phase container 8 to the sample injection unit 5. The sample injection unit 5 is a unit for injecting a measurement sample, and introduces the measurement sample into a flow path within the separation unit 2. The sample injection unit 5 is, for example, an autosampler. Various types of separation columns 6 can be used depending on the type of target component (compound), and preferable examples include reversed-phase columns such as a C18 column. The first detector 7 detects each target component separated by passing through the separation column 6 and outputs it as a chromatogram. Examples of the first detector 7 include an ultraviolet-visible spectrophotometric (UV) detector, a photodiode array (PDA) detector, and a fluorescence detector. Although not shown, a plurality of separation pumps 4, etc., may be provided according to the types of liquids contained in the mobile phase.

The purification unit 3 is means for purifying and recovering each target component separated from the separation unit 2, and includes a first flow path switching valve 9, a second flow path switching valve 10, an elution pump 11, a dilution pump 12, a trap column 13, a second detector 14, and a recovery unit 15.

The first flow path switching valve 9 is a valve that can select an arbitrary flow path from a plurality of flow paths, and is, for example, a six-port valve. The first flow path switching valve 9 can, by switching, guide the target component sent from the separation unit 2 to the trap column 13, or guide the elution organic solvent sent from the elution pump 11 to the trap column 13.

The second flow path switching valve 10 is located downstream of the first flow path switching valve 9 in the flow path, is a valve that can select an arbitrary flow path from a plurality of flow paths, and is, for example, a six-port valve. The second flow path switching valve 10 can, by switching, guide the target component sent from the separation unit 2 via the first flow path switching valve 9 to the trap column 13, guide the diluent sent from the dilution pump 12 to the trap column 13, or guide components sent from the separation unit 2 via the first flow path switching valve 9 to the outside of the fractionation apparatus 1.

The elution pump 11 is elution means, sends the elution organic solvent stored in the elution solvent container 16 to the trap column 13, and elutes the target component into the organic solvent. The dilution pump 12 sends a diluent stored in a diluent container 17 to the trap column 13. The trap column 13 is a column for purifying the target component, temporarily trapping the target component sent from the separation unit 2 and allowing unnecessary components other than the target component to pass through (be removed). The type of the trap column 13 is appropriately determined according to the target component, and specific examples include the Shim-pack series manufactured by Shimadzu Corporation. The second detector 14 detects each target component from the trap column 13 and outputs it as a chromatogram. Examples of the second detector 14 include the same types as the first detector 7. The recovery unit 15 is recovery means for storing each target component in a separate recovery container, and is, for example, a fraction collector. Although not shown, a plurality of elution pumps 11, dilution pumps 12, etc., may be provided according to the types of liquids contained in the elution organic solvent or the diluent.

A control unit 18, such as a computer, is attached to the fractionation apparatus 1. The control unit 18 is connected to various pumps (the separation pump 4, the elution pump 11, the dilution pump 12), the sample injection unit 5, each flow path switching valve 9, 10, and the recovery unit 15, respectively, and stores programs for controlling these. Specifically, the programs of the control unit 18 control the various pumps (the separation pump 4, the elution pump 11, the dilution pump 12) to adjust the inflow rate and flow rate of each liquid sent from each container (the mobile phase container 8, the elution solvent container 16, the diluent container 17). It controls the sample injection unit 5 to adjust the amount of the measurement sample introduced into the flow path. It controls each flow path switching valve 9, 10 to adjust the switching of the plurality of flow paths. It controls the recovery unit 15 to adjust the storage of each target component reaching the recovery unit 15 into each container for each target component and/or for each time period.

1-2. Fractionation Method An example of the fractionation method of the first embodiment used in the first aspect of the present invention will be described. This fractionation method uses the fractionation apparatus 1 and sequentially includes a preparation step and an implementation step.

(1) Preparation Step In this step, the measurement sample, mobile phase, diluent, and elution organic solvent are set in the fractionation apparatus 1.

Specifically, the measurement sample containing the target component is injected into the sample injection unit 5. Further, the mobile phase, the elution organic solvent, and the diluent are injected into the mobile phase container 8, the elution solvent container 16, and the diluent container 17, respectively. Each container may be singular or plural, and is appropriately set according to the type of liquid used. Also, depending on the number of containers, singular or plural pumps are prepared.

The mobile phase is appropriately determined according to the type of target component, the type of column, the separation mode, etc., but it is preferable to use a liquid used for reversed-phase mode. Specific examples include water, organic solvents, and the like. As the water for the mobile phase, for example, a buffer solution prepared by adding acetic acid, ammonium acetate, formic acid, ammonium formate, ammonia, or the like to water may be used. Examples of the organic solvent include alcohols such as methanol and ethanol, and, for example, acetonitrile, acetone, and the like. These may be used alone as one type or as a mixture of two or more types. When mixing, a mixed solvent prepared by mixing two or more types in advance may be injected into one mobile phase container, or a plurality of mobile phase containers 8 may be prepared, water or an organic solvent stored in each of these containers, and these liquids mixed in the flow path. The mobile phase preferably contains water, and more preferably is a mixed solution of water and an organic solvent. Thereby, reversed-phase chromatography can be performed, and a wide variety of compounds can be more reliably separated.

The diluent is a liquid for purifying the target component, may be any solvent immiscible with the target component, and is appropriately determined according to the target component. Examples of the diluent include water and organic solvents exemplified for the mobile phase. The diluent preferably contains water, and more preferably is water or a mixed solvent of water and an organic solvent. Thereby, unnecessary components adhering to the target component trapped in the trap column can be removed, and the target component can be washed (purified). In the first embodiment, preferably, at least one of the mobile phase and the diluent contains water.

The elution organic solvent may be any organic solvent in which the target component dissolves, and is appropriately determined according to the target component; examples include acetone, acetonitrile, dichloromethane, and the like. These may be used alone as one type or as a mixture of two or more types.

(2) Implementation Step In this step, each pump 4, 11, 12, each valve 9, 10, each detector 7, 14, and the control unit 18 of the fractionation apparatus 1 are operated to perform separation and purification of the target component.

Specifically, in the separation unit 2, the mobile phase is sent from the mobile phase container 8 by the operation of the separation pump 4. In the sample injection unit 5, the measurement sample mixes with the mobile phase and passes through the separation column 6. During passage, the measurement sample that has flowed into the separation column 6 flows out from the separation column 6 while being separated according to each target component (separation step). The separation liquid, consisting of the measurement sample and the mobile phase that has passed through the separation column 6, is detected by the first detector 7 and then reaches the purification unit 3. The first detector 7 outputs a chromatogram of the measurement sample. By checking the chromatogram, the separation of the target component and the elution time of the target component can be confirmed.

The sending speed of the mobile phase, and consequently the inflow rate V₁ of the mobile phase containing the measurement sample into the separation column 6, is not limited; it is, for example, 1 mL/min or more, preferably 2 mL/min or more, and, for example, 20 mL/min or less, preferably 10 mL/min or less.

Next, in the purification unit 3, as shown in FIG. 1, the separation liquid flows into the trap column 13 via the first flow path switching valve 9 and the second flow path switching valve 10 in sequence. At this time, by the operation of the dilution pump 12, the diluent is sent from the diluent container 17, merges with the separation liquid via the second switching valve, and the mixed liquid of the separation liquid and the diluent flows into the trap column 13. At this time, the target component is trapped in the trap column 13 (trapping step). Meanwhile, the mobile phase and the diluent flow out from the trap column 13 and are discharged to the outside of the fractionation apparatus 1 via the first flow path switching valve 9. Thereby, unnecessary components mixed in the separation liquid are discharged to the outside together with the diluent and the like.

Next, as shown in FIG. 2, by switching (rotating) the first flow path switching valve 9, operating the elution pump 11, and stopping the dilution pump 12, the elution organic solvent is sent from the elution solvent container 16 and flows into the trap column 13 via the first flow path switching valve 9. The trapped target component is eluted into the elution organic solvent (elution step) and flows out from the trap column 13 together with the elution organic solvent. Thereafter, the target component is detected by the second detector 14 via the second flow path switching valve 10 and the first flow path switching valve 9 in sequence, and is recovered in the recovery unit 15 (recovery step). The second detector 14 outputs a chromatogram of the target component.

In the purification unit 3, the trapping step and the elution step are performed intermittently or continuously, sectioned by target component type or by time. For example, by referencing the chromatogram obtained by the first detector 7 and switching the first flow path switching valve 9 and the second flow path switching valve 10 as needed to correspond to the peak shown by each target component, the desired target component is guided to the trap column 13 together with the mobile phase, and guided to the recovery unit 15 together with the elution organic solvent, as described above. On the other hand, the mobile phase not containing the target component (mobile phase at a retention time not showing a peak) is directly discharged to the outside of the fractionation apparatus 1 without passing through the trap column 13, by switching the first flow path switching valve 9 and/or the second flow path switching valve 10. These operations are repeated for each target component. Thereby, the target components are individually trapped in and eluted from the trap column 13 for each type.

At this time, the inflow rate of the diluent into the trap column 13 is not limited; it may be, for example, 1 mL/min or more, preferably 5 mL/min or more, and, for example, 50 mL/min or less, preferably 40 mL/min or less.

In the first embodiment, in the elution step, the sending speed of the elution organic solvent, and consequently the inflow rate V₂ of the elution organic solvent into the trap column 13, is adjusted to a speed at which water and the target component are separated among the liquids flowing out from the trap column 13. Specifically, the inflow rate V₂ is set to, for example, 1 mL/min or less, preferably 0.8 mL/min or less, more preferably 0.6 mL/min or less, and even more preferably 0.5 mL/min or less. The lower limit is not limited, but may be, for example, 0.1 mL/min or more from the viewpoint of fractionation completion time. Further, the ratio (V₂/V₁) of the inflow rate V₂ of the elution organic solvent into the trap column 13 to the inflow rate V₁ of the mobile phase into the separation column 6 is, for example, 0.3 or less, preferably 0.2 or less, more preferably 0.15 or less, and, for example, 0.01 or more, preferably 0.05 or more. By setting the inflow rate V₂ or the above ratio within the above range, water can be reliably eliminated during the fractionation of the target component.

In the recovery step, recovery in the recovery unit 15 is performed, sectioned by target component or by time. That is, based on the chromatogram obtained by the second detector 14, the peak indicating the target component is fractionated, and each fractionated target component is stored in each recovery container. Thereby, only a desired part of the target components arriving continuously can be fractionated. In particular, the target component in a state not containing water can be fractionated together with the elution organic solvent.

The target component recovered in the recovery step may then be analyzed using an analyzer such as a nuclear magnetic resonance spectrometer (analysis step). Thereby, the details of the target component can be grasped.

According to the first embodiment, water contamination can be suppressed in the fractionated target component. This is presumed as follows. Conventionally, in the elution step, components discharged from the trap column 13 include the mobile phase and diluent remaining from the trapping step, in addition to the target component and the elution organic solvent, and at least one of this mobile phase and diluent contains water. Therefore, water also mixes into the finally recovered target component. In contrast, according to the first embodiment, the inflow rate of the elution organic solvent into the trap column 13 is controlled so that water does not mix into the recovered target component. Specifically, the inflow rate is significantly reduced. This significantly delays the time it takes for the target component to come into contact with the elution organic solvent and be eluted. For this reason, water starts to be discharged from the trap column 13 before the target component is discharged from the trap column 13. That is, water is sufficiently discharged first, and subsequently, the target component is discharged. Therefore, for the target component recovered in the recovery unit 15, by fractionating a desired portion based on the peak of the chromatogram from the second detector 14, water contamination can be suppressed in the obtained target component. As a result, when analyzing the target component, there is no need to remove water by distillation or the like, and fractionation and analysis of the target component can be performed smoothly.

In the example of the first embodiment above, the application of a nuclear magnetic resonance spectrometer is exemplified as the analysis step, but as another application example, the present invention can also be applied to measurements with other apparatuses that are affected when water is included. Examples of such other apparatuses include a gas chromatograph, an ultraviolet spectroscopic detector, a Fourier transform infrared spectrometer, and the like.

### Aspects

It will be understood by those skilled in the art that the exemplary embodiments described above are specific examples of the following aspects.

(Item 1) A fractionation method according to one aspect, being a method for fractionating a target component from a measurement sample, may comprise a separation step of separating the target component by passing the measurement sample together with a mobile phase through a separation column, a trapping step of trapping the separated target component in a trap column, an elution step of causing the target component to flow out from the trap column by causing an elution organic solvent to flow into the trap column, and a recovery step of recovering the target component that has flowed out from the trap column, wherein, in the elution step, water and the target component discharged from the trap column may be separated by adjusting an inflow rate of the elution organic solvent into the trap column.

(Item 2) In the fractionation method according to item 1, the inflow rate may be 1 mL/min or less.

(Item 3) In the fractionation method according to item 1or 2, the inflow rate may be 0.6 mL/min or less.

(Item 4) In the fractionation method according to any one of items 1 to 3, after the recovery step, the target component may be analyzed by a nuclear magnetic resonance spectrometer.

(Item 5) A fractionation apparatus according to one aspect, being an apparatus for implementing the fractionation method according to any one of items 1 to 4, may comprise a separation column for separating the target component, a trap column for trapping the separated target component, elution means for causing the elution organic solvent to flow into the trap column, recovery means for recovering the target component that has flowed out from the trap column, and control means for adjusting the inflow rate of the elution organic solvent into the trap column.

### Example

Next, the present invention will be described in detail by giving Examples and Comparative Examples, but the scope of the present invention is not limited by these.

### Example 1

As a chromatographic preparative purification apparatus, an ultra-fast preparative and trap purification system "Nexera UFPLC" (manufactured by Shimadzu Corporation) was used. As the measurement sample (target component), guaiazulene, which exhibits a blue color, was used. A separation step, a trapping step, an elution step, and a recovery step were performed under the measurement conditions shown below (see FIGS. 1 and 2).

### LC Fractionation Unit

Mobile phase: Methanol Mobile phase inflow rate: 4 mL/min Separation column: Not used (for analysis of standard sample) Measurement sample injection volume: 100 μL UV detector detection wavelength: 230 nm ("SPD-20A", manufactured by Shimadzu Corporation)

### Purification Unit

Diluent: Water Diluent inflow rate: 8 mL/min Elution organic solvent: Dichloromethane Elution organic solvent inflow rate: 0.5 mL/min Trap column: Shim-Pack UFPLC 20x30 (35 mm x 8 mm I.D., 20-30 μm) UV detector detection wavelength: 254 nm ("SPD-20A", manufactured by Shimadzu Corporation)

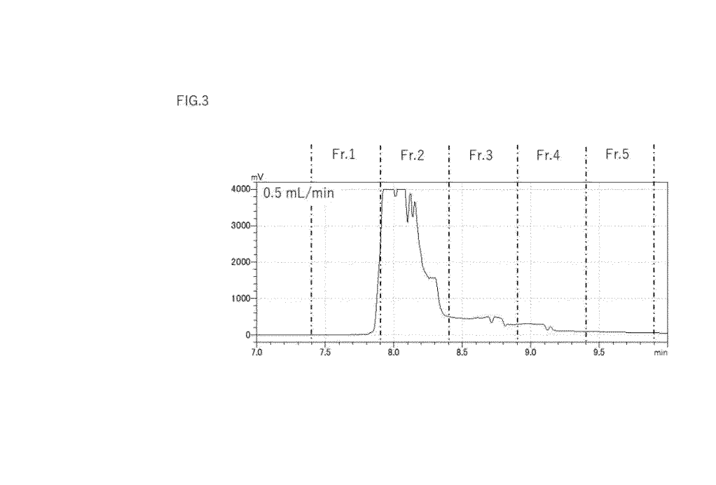

FIG. 3 shows a chromatogram obtained by the UV detector (second detector 14) in the purification unit. Regarding this, the component fractionated (recovered) from 7.4 to 7.9 min was designated as Fraction 1 (Fr. 1), the component fractionated from 7.9 to 8.4 min as Fraction 2 (Fr. 2), the component fractionated from 8.4 to 8.9 min as Fraction 3 (Fr. 3), the component fractionated from 8.9 to 9.4 min as Fraction 4 (Fr. 4), and the component fractionated from 9.4 to 9.9 min as Fraction 5 (Fr. 5), and recovered. When these were placed in test tubes and observed, it was observed that the liquid recovered as Fraction 2 did not show layer separation and exhibited only a blue color. That is, it was found that water was substantially not mixed in.

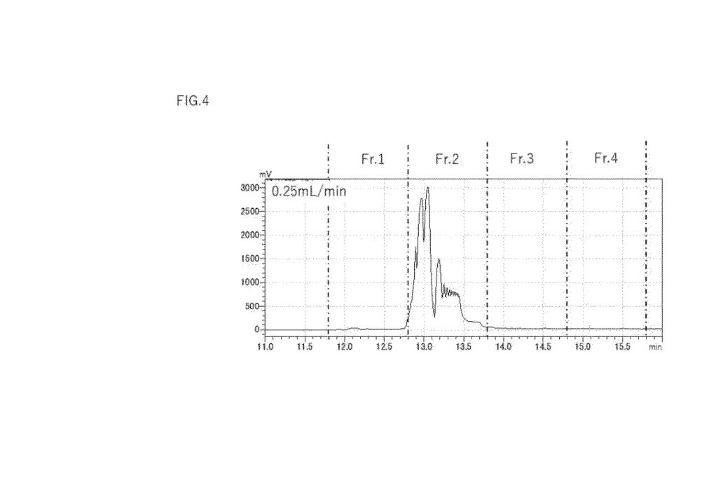

(Example 2) The procedure was the same as in Example 1, except that the inflow rate of the elution organic solvent was changed to 0.25 mL/min. FIG. 4 shows a chromatogram obtained by the UV detector in the purification unit. Fractionation was performed as shown by the dash-dotted line in FIG. 4, and each fraction was recovered. When the liquid of Fraction 2 was observed, it was observed that the liquid did not show layer separation and was composed of a dark blue liquid (a mixed liquid of guaiazulene and the organic solvent). That is, it was found that water was substantially not mixed in.

### Example 3

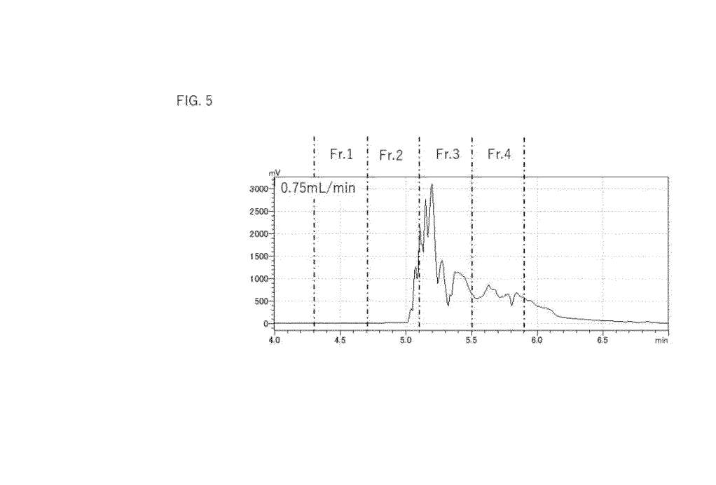

The procedure was the same as in Example 1, except that the inflow rate of the elution organic solvent was changed to 0.75 mL/min. FIG. 5 shows a chromatogram obtained by the UV detector in the purification unit. Fractionation was performed as shown in FIG. 5, and each fraction was recovered. When the liquid of Fraction 3 was observed, a transparent liquid was observed near the liquid surface, and layer separation between the transparent liquid (water) and the dark blue liquid had occurred. That is, a slight amount of water was mixed in. When the degree of water contamination was measured, it was 5% by volume or less relative to the blue liquid.

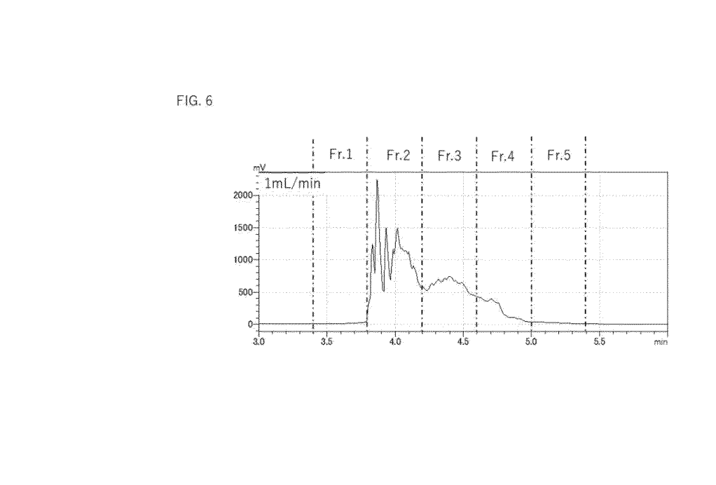

(Example 4) The procedure was the same as in Example 1, except that the inflow rate of the elution organic solvent was changed to 1 mL/min. FIG. 6 shows a chromatogram obtained by the UV detector in the purification unit. Fractionation was performed as shown in FIG. 6, and each fraction was recovered. When the liquid of Fraction 2 was observed, a transparent liquid was observed near the liquid surface, and layer separation between the transparent liquid (water) and the dark blue liquid had occurred. That is, a slight amount of water was mixed in. When the degree of water contamination was measured, it was 5% by volume or less relative to the dark blue liquid.

### Comparative Example 1

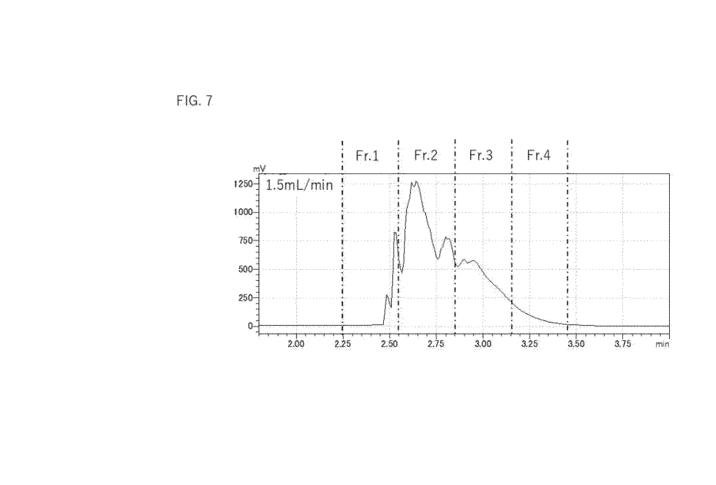

The procedure was the same as in Example 1, except that the inflow rate of the elution organic solvent was changed to 1.5 mL/min. FIG. 7 shows a chromatogram obtained by the UV detector in the purification unit. Fractionation was performed as shown in FIG. 7, and each fraction was recovered. When the liquid of Fraction 2 was observed, a transparent liquid was observed in its upper part, and layer separation between the transparent liquid (water) and the dark blue liquid had occurred. That is, a large amount of water was mixed in. When the degree of water contamination was measured, it exceeded 10% by volume relative to the dark blue liquid.

### Comparative Example 2

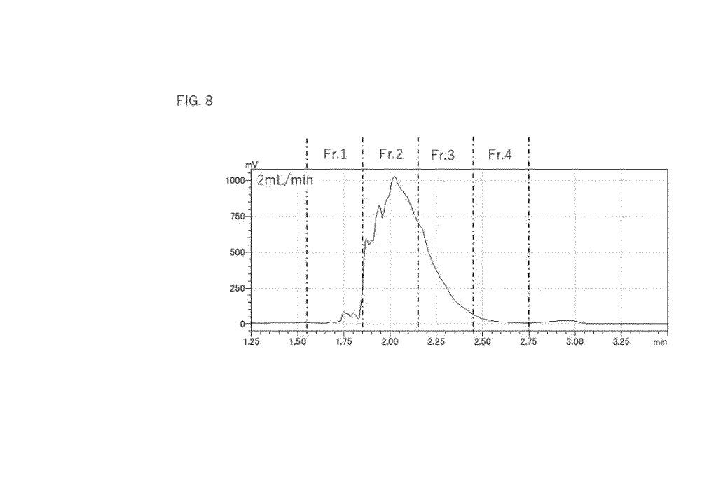

The procedure was the same as in Example 1, except that the inflow rate of the elution organic solvent was changed to 2 mL/min. FIG. 8 shows a chromatogram obtained by the UV detector in the purification unit. Fractionation was performed as shown in FIG. 8, and each fraction was recovered. When the liquid of Fraction 2 was observed, a transparent liquid was observed in its upper part, and layer separation between the transparent liquid (water) and the dark blue liquid had occurred. That is, a large amount of water was mixed in. When the degree of water contamination was measured, it exceeded 10% by volume relative to the dark blue liquid.

### Comparative Example 3

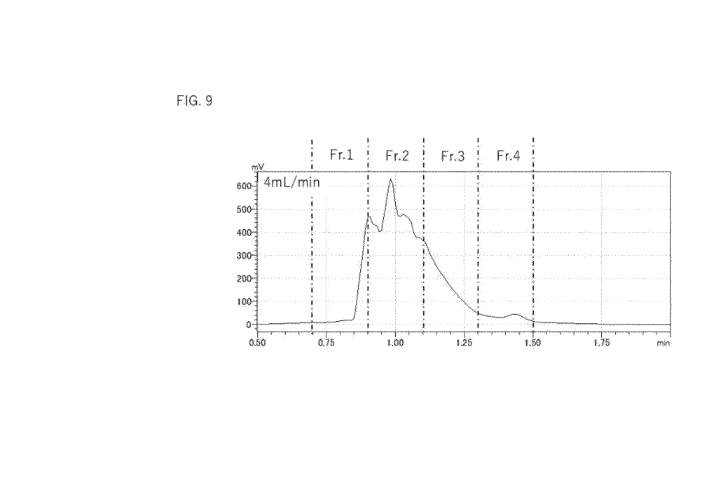

The procedure was the same as in Example 1, except that the inflow rate of the elution organic solvent was changed to 4 mL/min. FIG. 9 shows a chromatogram obtained by the UV detector in the purification unit. Fractionation was performed as shown in FIG. 9, and each fraction was recovered. When the liquid of Fraction 2 was observed, a transparent liquid was observed in its upper part, and layer separation between the transparent liquid (water) and the dark blue liquid had occurred. That is, a large amount of water was mixed in. When the degree of water contamination was measured, it exceeded 10% by volume relative to the dark blue liquid.

### REFERENCE SIGNS LIST

1 Fractionation apparatus 2 Separation unit 3 Purification unit 4 Separation pump 5 Sample injection unit 6 Separation column 7 First detector 8 Mobile phase container 9 First flow path switching valve 10 Second flow path switching valve 11 Elution pump 12 Dilution pump 13 Trap column 14 Second detector 15 Recovery unit 16 Elution solvent container 17 Diluent container 18 Control unit

1. A fractionation method for fractionating a target component from a measurement sample, comprising: a separation step of separating the target component by passing the measurement sample together with a mobile phase through a separation column; a trapping step of trapping the separated target component in a trap column; an elution step of causing the target component to flow out from the trap column by causing an elution organic solvent to flow into the trap column; and a recovery step of recovering the target component that has flowed out from the trap column, wherein, in the elution step, water and the target component discharged from the trap column are separated by adjusting an inflow rate of the elution organic solvent into the trap column.

2. The fractionation method according to claim 1, wherein the inflow rate is 1 mL/min or less.

3. The fractionation method according to claim 1, wherein the inflow rate is 0.6 mL/min or less.

4. The fractionation method according to claim 1, wherein, after the recovery step, the target component is analyzed by a nuclear magnetic resonance spectrometer.

5. An apparatus for implementing the fractionation method according to claim 1, comprising: a separation column for separating the target component; a trap column for trapping the separated target component; elution means for causing the elution organic solvent to flow into the trap column; recovery means for recovering the target component that has flowed out from the trap column; and control means for adjusting the inflow rate of the elution organic solvent into the trap column.
